(19) United States
(12) Patent Application Publication
(10) Pub. No.: US 2007/0193985 A1
(43) Pub. Date: Aug. 23, 2007

(54) METHOD FOR REMOVING A COATING FROM A SUBSTRATE USING A DEFOCUSED LASER BEAM

(76) Inventors: Patrick C. Howard, Austin, TX (US); Charles Mitchell, Austin, TX (US); Sywong Nigin, Austin, TX (US)

Correspondence Address: 3M INNOVATIVE PROPERTIES COMPANY, PO BOX 33427, ST. PAUL, MN, 55133-3427, US

(21) Appl. No.: 11/276,239

(22) Filed: Feb. 20, 2006

(51) Int. Cl. B23K 26/38

(52) U.S. Cl. 219/121.69

(57) ABSTRACT

A defocused laser beam provides an efficient mechanism to remove a coating from a substrate without requiring additional cleaning steps. A defocused laser beam is applied to the coating so that a focal point of the laser beam does not spatially coincide with the coating. A target portion of the coating is removed by applying sufficient power from the laser beam to ablate the material of the target portion and expose a portion of the substrate underlying the target portion.

### FIELD OF THE INVENTION

The present invention relates generally to methods for removing coatings from substrates. In particular, the present invention relates to methods for using laser beams to remove coatings from substrates.

### BACKGROUND OF THE INVENTION

Various applications require removing coatings, or portions of coatings, from coated substrates. Conventional methods for removing coatings from substrates include using volatile organic compounds (VOCs) or acids, abrasive techniques, or highly focused laser beams. These methods may be complicated, labor intensive, time consuming, and/or hazardous to personnel. In addition, these methods may pose pollution concerns and may damage the underlying substrate.

In the electrical industry, highly focused laser beams are applied to insulating coatings of flat flexible cables (FFCs) to ablate portions of the insulating coatings and expose underlying conductors to enable electrical connections to be established with the conductors. To accomplish this, a laser beam is typically focused onto the surface of the insulating coating. The laser beam is then moved across the coating in a series of adjacent paths to ablate the coating and expose one or more underlying conductors. During the ablation process, deposition of airborne ablated material back onto exposed portions of the conductor often occurs due to incomplete material vaporization along the perimeter of the ablated region. To establish robust electrical connections, additional cleaning steps may be required to remove the deposited material from the exposed conductor.

### BRIEF SUMMARY OF THE INVENTION

The present invention is a method for removing a coating from a substrate. A defocused laser beam is applied to the coating so that a focal point of the laser beam does not spatially coincide with the coating. A target portion of the coating is removed by applying sufficient power from the laser beam to expose a portion of the substrate underlying the target portion.

### BRIEF DESCRIPTION OF THE DRAWINGS

FIG. 1A is a schematic drawing of a coated substrate upon application of a defocused laser beam.

FIG. 1B is a schematic drawing of the coated substrate of FIG. 1A after application of sufficient power via the defocused laser beam to ablate a portion of coating and expose a portion of an underlying substrate.

FIG. 1C is a top schematic view of the coated substrate of FIG. 1B after ablating the portion of the coating.

FIG. 2A is a perspective view of a flat flexible cable.

FIG. 2B is a sectional view as taken along line 2B-2B of FIG. 2A.

FIG. 3A is a perspective view of the flat flexible cable of FIG. 2A after application of a defocused laser beam to a target portion of coating located at an intermediate location along the flat flexible cable.

FIG. 3B is a sectional view as taken along line 3B-3B of FIG. 3A.

FIG. 3C is a sectional view as taken along line 3C-3C of FIG. 3A.

FIG. 4A is a perspective view of the flat flexible cable of FIG. 2A after application of a defocused laser beam to a target portion of coating located at an end of the flat flexible cable.

FIG. 4B is a sectional view as taken along line 4B-4B of FIG. 4A.

FIG. 5A is a perspective view of a flat ribbon cable.

FIG. 5B is a sectional view as taken along line 5B-5B of FIG. 5A.

FIG. 6A is a perspective view of the flat ribbon cable of FIG. 5A after application of a defocused laser beam to a target portion of coating located at an intermediate location along the flat ribbon cable.

FIG. 6B is a sectional view as take along line 6B-6B of FIG. 6A.

FIG. 6C is a sectional view as take along line 6C-6C of FIG. 6A.

FIG. 7A is a perspective view of the flat ribbon cable of FIG. 5A after application of a defocused laser beam to a target portion of coating located at an end of the flat ribbon cable.

FIG. 7B is a sectional view as taken along line 7B-7B of FIG. 7A.

FIG. 8 is a photograph of a flat flexible cable after application of a defocused laser beam pursuant to the method of the present invention.

FIG. 9 is a photograph of a flat flexible cable after application of a focused laser beam pursuant to conventional methods.

While the above-identified drawing figures set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale. Like reference numbers have been used throughout the figures to denote like parts.

### DETAILED DESCRIPTION

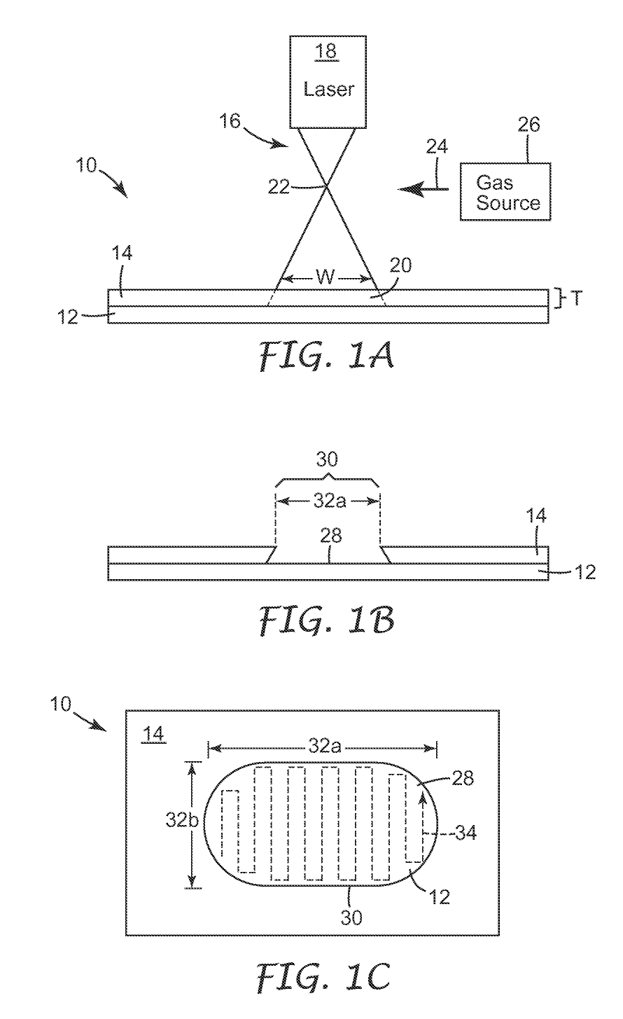

The present invention is a method for using a defocused laser beam to remove one or more portions of a coating from a substrate. FIGS. 1A-1C illustrate an embodiment of the method of the present invention, with FIG. 1A showing a schematic representation of coated substrate 10 upon application of a defocused laser beam and FIGS. 1B and 1C showing a schematic representation of coated substrate 10 after application of the defocused laser beam.

As shown in FIG. 1A, coated substrate 10 includes substrate 12 coated with coating 14, which has thickness T. Defocused laser beam 16, generated by laser 18, is applied to target portion 20 of coating 14. Defocused laser beam 16 has beam width W at target portion 20 and includes focal point 22, which is located above coating 14 so that it does not spatially coincide with target portion 20. As used herein, the term “defocused laser beam” refers to a laser beam having a beam profile with a focal point that does not spatially coincide with a target plane. The term further includes laser beams that do not have a focal point (which are also referred to herein as “unfocused laser beams”).

Focal point 22 may be a substantially compact or discrete point of defocused laser beam 16 (as shown in FIG. 1A.) or a cross-sectional narrowing of defocused laser beam 16. As shown in FIG. 1A, defocused laser beam 16 is configured so that focal point 22 is located in a focal plane above coating 14. In some embodiments, laser beam 16 is configured so that focal point 22 is located in a focal plane below coating 14. In such embodiments, focal point 22 is not physically located below coating 14, but rather would be physically located below coating 14 if coated substrate 10 were removed from the path of defocused laser beam 16.

As shown in FIG. 1A, assist gas 24 may be supplied by gas source 26 to aid in the removal of airborne ablated material produced during removal of target portion 20. Assist gas 24 may help prevent redeposition of ablated material from target portion 20 onto substrate 12. Assist gas 24 may be any gas or combination of gasses known in the art including, for example, inert gasses such as nitrogen gas.

FIG. 1B shows a schematic representation of coated substrate 10 after application of sufficient power by defocused laser beam 16 to ablate the material of target portion 20 and expose portion 28 of substrate 12. The ablation of target portion 20 results in formation of window 30 in coating 14 having dimension 32a. In some embodiments, beam width W of defocused laser beam 16 is substantially the same size or larger than dimension 32a.

FIG. 1C shows a top schematic view of coated substrate 10 of FIG. 1B. Window 30 having dimensions 32a and 32b is created using a single pass of defocused laser beam 16 relative to coating 14. FIG. 1C also shows conventional laser path 34 to illustrate the multiple adjacent laser beam passes that may be required to create window 30 pursuant to conventional focused laser beam methods. In these conventional methods (where focal point 22 is located directly onto target portion 20), multiple adjacent passes may be required to create window 30 due to the narrow beam width at focal point 22. As discussed above, the use of multiple adjacent laser beam passes to ablate may result in redeposition of ablated materials back onto substrate 12, which, for certain applications, may necessitate subsequent cleaning steps to sufficiently remove the redeposited material.

Width W of defocused laser beam 16 may be tailored for a particular application to achieve a desired dimension 32a and/or 32b. This may be accomplished by any suitable method including, for example, altering the distance between laser 18 and target portion 20 and inserting, moving, or removing one or more lenses from a path of defocused laser beam 16. In addition, in some embodiments, masks may be used to shield portions of target portion 20 from defocused laser beam 16. As such, in some embodiments, width W may be substantially the same size or larger than dimension 32a or 32b of window 30. In some embodiments, width W at target portion 20 may be as wide as about one inch (or about 2.5 centimeters).

To enlarge window 30 (and, thus, exposed portion 28 of substrate 12), width W may be increased. Alternatively, defocused laser beam 16 may be moved relative to coating 14. This may be accomplished by any feasible method including, for example, moving laser 18 and/or coated substrate 10.

Window 30 is shown as an oval in FIG. 1C created by movement of defocused laser beam 16 relative to coating 14, with defocused laser beam 16 having a circular cross-sectional beam profile. In other embodiments, window 30 may be any other suitable shape known in the art, including for example, circles (e.g., when defocused laser beam 16 is not moved relative to coating 14), squares, rectangles, triangles, etc.

The method of the present invention may be used to remove coatings 14 having various thicknesses T (FIG. 1A) and formed from various compositions. While not wishing to be bound by theory, the ability of defocused laser beam 16 to remove target portion 20 may depend upon the material of target portion 20, the power density of defocused laser beam 16 at target portion 20, and/or the particular thickness T of target portion 20. The method of the present invention may be used to remove virtually any type of coating 14 having a relatively thin thickness T. In some embodiments, the method of the present invention may be used to remove a coating 14 having a relatively thick thickness T such as, for example, a relatively thick electrical insulating coating. Examples of relatively thick electrical insulating coatings that may be removed using the method of the present invention include relatively thick coatings formed from polyethylene, polyvinyl, polypropylene, polyamide, other polymers known in the art, and combinations thereof.

Any type of suitable laser 18 known in the art may be used in conjunction with the method of the present invention. In an exemplary embodiment, laser 18 is a carbon dioxide laser.

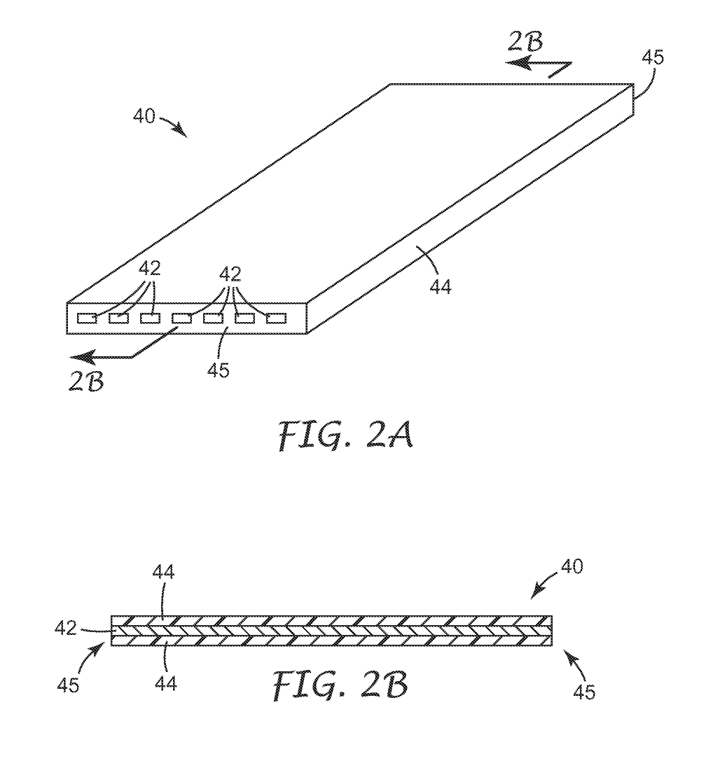

The method of the present invention may be used to remove insulation from electrical cables to form one or more electrical contacts for establishing electrical connections with conductors located within the cables. FIGS. 2A-7B illustrate electrical contacts that may be formed in flat cables using the method of the present invention to remove portions of insulating layers to expose underlying conductors. Unlike conventional focused laser beam methods, the method of the present invention allows robust electrical connections to be made to the exposed conductor substrate without additional mechanical or chemical cleaning steps to remove residual coating material from the exposed conductors that may interfere with the electrical connections. The size of width W of defocused laser beam 16 eliminates the need for subsequent cleaning steps by avoiding redeposition of ablated coating material.

As shown in FIGS. 2A-4B, the method of the present invention may be used to remove portions of an electrical insulating layer from a flexible flat cable (FFC) to produce one or more electrical contacts at any location of the FFC. FIGS. 2A and 2B show FFC 40 prior to application of defocused laser beam 16, with FIG. 2A showing a perspective view of FFC 40 and FIG. 2B showing a cross sectional view of FFC 40. As shown in FIGS. 2A and 2B, FFC 40 includes a plurality of conductors 42 encased by electrical insulating coating 44. Conductors 42 extend the length of FFC 40 between ends 45.

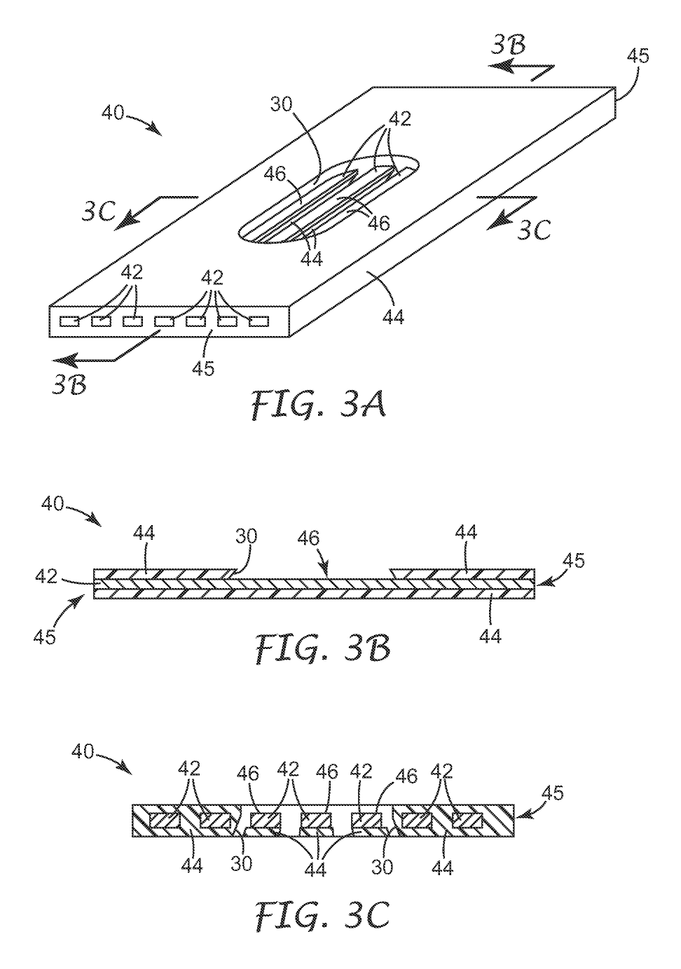

FIGS. 3A-3C show FFC 40 after application of defocused laser beam 16 to an intermediate portion of coating 44 to expose a plurality of conductors 42 and form intermediate electrical contacts 46. Electrical contact 46 is bounded by window 30 formed in coating 44. Electrical contact 46 can include exposed portions of any number of conductors 42. In one embodiment, electrical contact 46 includes an exposed portion of a single conductor 42.

The power density of defocused laser beam 16 and/or the duration of exposure to defocused laser beam 16 may be altered to control the depth of ablation of coating 44. As shown in FIG. 3C, the portions of coating 44 overlying, and located between, conductors 42 have been removed. In some embodiments, the conditions may be controlled so the portion of coating 44 overlying conductor(s) 42 is removed, while the portion of coating 44 residing under and between conductor(s) 42 remains intact.

In some applications, it may be desirable to bend (or bow) electrical contact(s) 46 of FFC 40 outward to facilitate establishment of electrical connections with contact(s) 46. This may be accomplished, for example, by forming opposing cuts (not shown in FIG. 3A) in coating 44 along window 30 that allow electrical contact(s) 46 to be bent outward. The cuts may be formed using die-cut methods or highly focused laser beams. When using a highly focused laser beam to form the opposing cuts, the opposing cuts are preferably formed prior to removal of coating 44 with defocused laser beam 16 to form electrical contact(s) 46 to prevent redeposition of ablated materials on electrical contact(s) 46. FFC 40 may be die-cut either before or after application of defocused beam 16 to form electrical contact(s) 46.

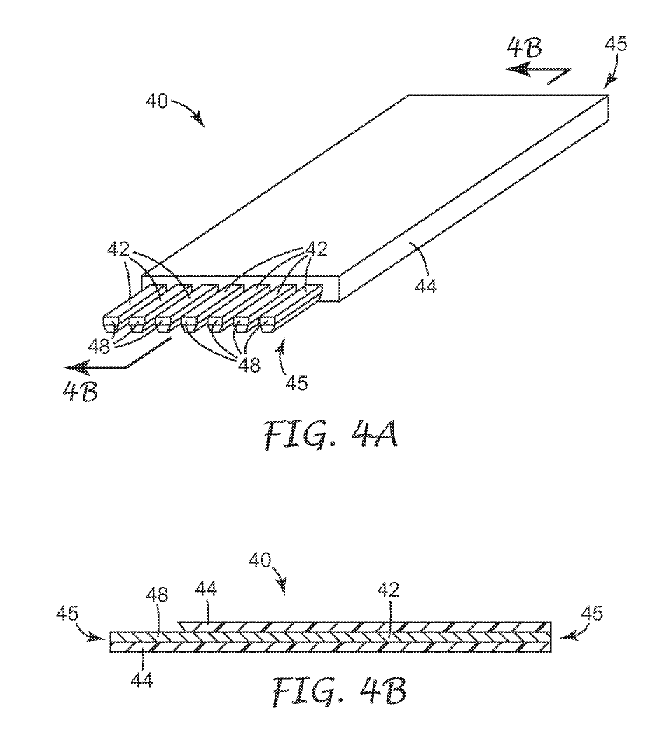

FIGS. 4A and 4B show FFC 40 after application of defocused laser beam 16 to an end portion of coating 44 to expose conductors 42 and form end electrical contacts 48 located at one of ends 45. In some embodiments, conductors 42 are selectively exposed to form one or more end electrical contacts 48 at one or both of ends 45.

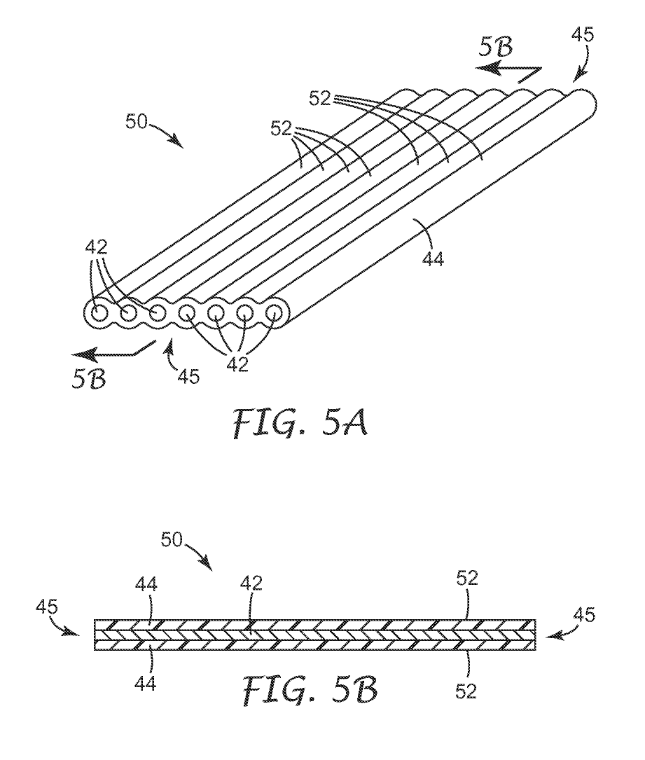

As shown in FIGS. 5A-7B, the method of the present invention may be used to remove portions of an electric insulating layer from a flat ribbon cable to produce one or more electrical contacts at any location of the flat ribbon cable. FIGS. 5A and 5B show flat ribbon cable 50 prior to application of defocused laser beam 16, with FIG. 5A showing a perspective view of flat ribbon cable 50 and FIG. 5B showing a cross sectional view of flat ribbon cable 50. Flat ribbon cable 50 is similar to FFC 40 in that it includes a plurality of conductors 42 encased in coating 44 and extending between a pair of ends 45. Unlike FFC 40, however, coating 44 is formed from a plurality of coatings 52 that are connected to form coating 44.

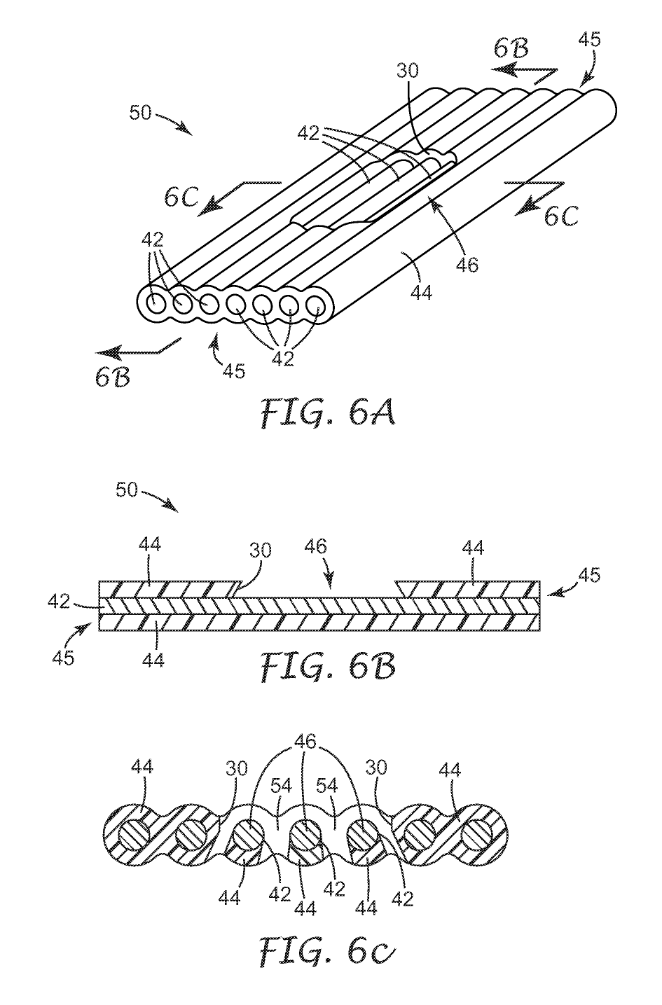

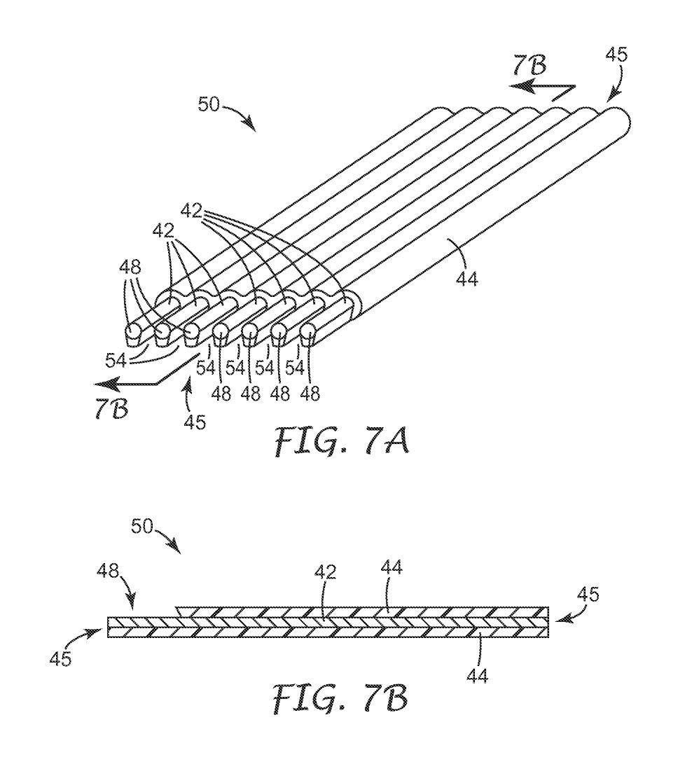

Similar to FIGS. 3A-3C for FFC 40, FIGS. 6A-6C show flat ribbon cable 50 after application of defocused laser beam 16 to an intermediate portion of flat ribbon cable 50 to produce intermediate electrical contact 46. Likewise, similar to FIGS. 4A and 4B for FFC 40, FIGS. 7A and 7B show flat ribbon cable 50 after application of defocused laser beam 16 to form end electrical contacts 48 located at one of ends 45. Sufficient power was applied to coating 44 via defocused laser beam 16 to form gaps 54 extending through coating 44. As described above for FFC 40, the amount of applied power to coating 44 of flat ribbon cable 50 may be controlled to achieve any desired degree of ablation of coating 44.

The above electrical contacts 46 and 48 may be of any size, may include any number of conductors 42, and may be included in any combination or location on FFC 40 or flat ribbon cable 50.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

Example 1 illustrates an embodiment of the method of the present invention for forming an electrical contact in a FFC using a defocused laser beam, while Comparative Example A illustrates a conventional method for forming an electrical contact using a focused laser beam. The FFC used in Example 1 and Comparative Example A included a copper conductor coated with a 0.175 mm thick thermoplastic urethane (TPU) insulating layer.

### Example 1

### Formation of an Electrical Contact in a FFC Using a Defocused Laser Beam

A defocused laser beam was used to form an intermediate electrical contact in a FFC as described below. A defocused laser beam with a substantially circular beam profile was generated using a 360 Watt CO₂ laser set at 100% power. The defocused laser beam was applied to the TPU insulating layer so that the focal point of the defocused laser beam was located 20.32 millimeters (mm) above the surface of the TPU insulating layer. The width of the defocused laser beam at the surface of the TPU insulating layer was about 1.62 mm.

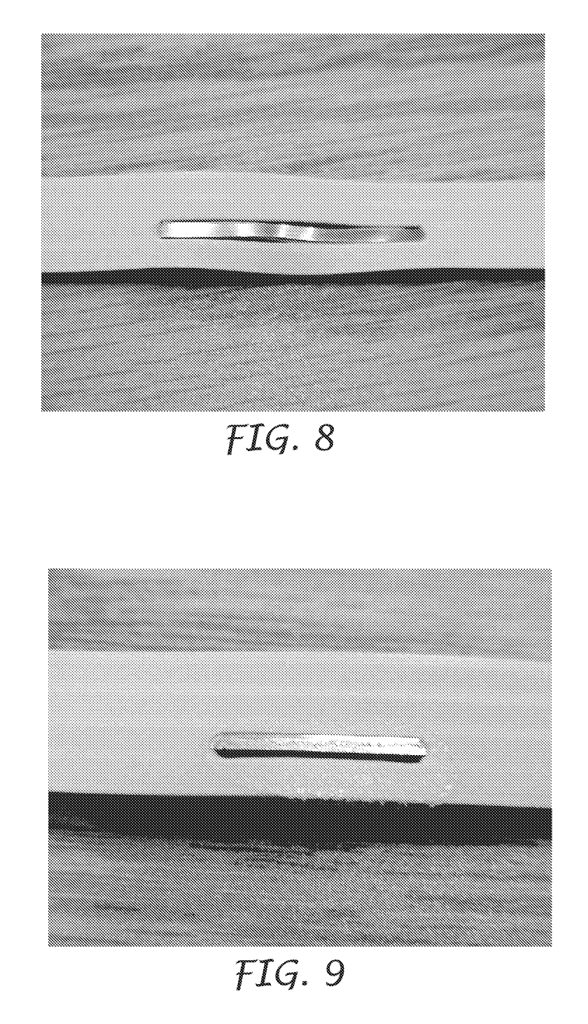

Using a feed rate of about 15.24 meters per minute, the FFC was moved longitudinally relative to the defocused laser beam to ablate the TPU insulating layer and expose the underlying copper conductor. A 1.62 mm wide by 30 mm long window was formed though the TPU insulating layer using a single longitudinal pass of the defocused laser beam. A photograph of the resulting electrical contact is shown in FIG. 8.

### Comparative Example A

### Formation of an Electrical Contact in a FFC using a Focused Laser Beam

A conventional focused laser beam was used to form an intermediate electrical contact in a FFC as described below. A laser beam having a substantially circular beam profile was generated using a 360 Watt CO₂ laser set at 20% power. The laser beam was applied to the TPU insulating layer so that the focal point of the laser beam was located at the surface of the TPU insulating layer. The width of the focused laser beam at the surface of the TPU insulating layer was about 0.15 mm.

Using a conventional beam path similar to beam path 34 of FIG. 1C, the focused laser beam was moved crosswise relative to the TPU insulating layer at a rate of about 15.24 meters per minute. Multiple adjacent crosswise beam passes were employed, with the focused laser beam moving longitudinally relative to the TPU insulating layer at a rate of about 0.0094 meters per minute (or about 9.4 mm/minute). After about 236 adjacent crosswise beam passes, a window measuring about the same size as the window of Example 1 was formed through the TPU insulating layer. A photograph of the resulting electrical contact is shown in FIG. 9.

Comparison of the Electrical Contacts of the FFCs of Example 1 and Comparative Example A

After laser ablating the TPU insulating layer using the methods of Example 1 and Comparative Example A, the resulting laser-ablated FFC samples were analyzed to assess the relative amount of residual material present on the surface of the copper conductor. A Nicolet Nexus 670 FTIR equipped with a Continum microscope was used to determine the absorbance of a 1-millimeter square sample of copper surface exposed via laser ablation (hereinafter “exposed copper surface”) of the FFC samples of Example 1 and Comparative Example A. The absorbance of each sample was measured over a wide range of wavelengths, with the absorbance of each sample at 770 cm⁻¹ selected for quantization. The absorbance of the exposed copper surface of Example 1 at 770 cm⁻¹ was determined to be 0.031. The absorbance for a visually clean area of the exposed copper surface of Comparative Example A at 770 cm⁻¹ was determined to be 0.537, while the absorbance of a randomly selected area of the exposed copper surface of Comparative Example A at 770 cm⁻¹ was determined to be 0.62. As such, the exposed copper surface of Example 1 exhibited an absorbance at 770 cm⁻¹ that was between about 17 and about 20 times less than the absorbance of the exposed copper surface of Comparative Example A.

Since the absorbance of a material varies linearly with thickness, the thickness of the residual coating on the exposed copper surface of Example 1 was between about 17 and about 20 times thinner than the thickness of the residual coating on the exposed copper surface of Comparative Example A. The maximum absorbance of the exposed copper surface of Example 1 at the wavelengths tested indicated that the thickness of the residual coating overlying the exposed copper surface of Example 1 was on the order of a few microns. Given the above residual coating thickness ratio for Example 1 and Comparative Example A, the thickness of the residual coating overlying the exposed copper surface of Comparative Example A was on the order of at least about 20 microns. The content of the residual coatings of Example 1 and Comparative Example A was analyzed and determined to be composed of residual material from the ablated TPU insulating layer.

Thus, as described above, the method of the present invention provides an efficient process for removing a portion of a coating from a coated substrate. A defocused laser beam is used to apply sufficient power to a target region of a coating to ablate the coating and expose an underlying substrate. Unlike conventional techniques using highly focused laser beams, conductor substrates exposed using the method of the present invention do not require additional cleaning steps to function as a suitable electrical contact.

Although the present invention has been described with reference to preferred embodiments, workers skilled in the art will recognize that changes may be made in form and detail without departing from the spirit and scope of the invention.

1-19. (canceled)

20. A method comprising:
applying a defocused laser beam to a flat cable comprising a coating overlying a substrate such that a focal point of the laser beam does not spatially coincide with the coating, the substrate comprising a conductor of the flat cable and the coating comprising insulation of the flat cable;
applying the defocused laser beam at an intermediate portion of the coating of the flat cable on only one planar side of the coating of the flat cable; and
removing a target portion of the coating from the substrate with the defocused laser beam at an intermediate portion of the coating of the flat cable on only one planar side of the coating of the flat cable by applying sufficient power from the defocused laser beam to ablate material from the target portion and expose a portion of the substrate underlying the coating, without substantially removing coating from the intermediate portion of the coating of the flat cable on the opposite planar side of the coating of the flat cable.

21. The method of claim 20, further comprising
maintaining the flat cable in a fixed position; and
moving a defocused laser beam in a planar fashion relative to the flat cable.

22. The method of claim 20, further comprising:
supplying a nitrogen gas to remove airborne material produced during removal of the target portion of coating to prevent deposition of airborne material on the exposed portion of the substrate thereby clearing the substrate and enabling a substantially clean electrical connection of an electrical component with an exposed portion of the substrate.

23. A method comprising:
applying a defocused laser beam to a coating overlying a substrate such that a focal point of the laser beam does not spatially coincide with the coating;
removing a target portion of the coating from the substrate with the defocused laser beam by applying sufficient power from the defocused laser beam to ablate material from the target portion and expose a portion of the substrate underlying the coating; and
supplying a nitrogen gas to remove airborne material produced during removal of the target portion of coating deposition of airborne material on the exposed portion of the substrate thereby clearing the substrate and enabling a substantially clean electrical connection of an electrical component with an exposed portion of the substrate.

24. The method of claim 23, wherein the substrate comprises a conductor of a flat flexible cable and the coating comprises insulation of the flat flexible cable.

25. The method of claim 23, further comprising
maintaining the flat cable in a fixed position; and
moving a defocused laser beam in a planar fashion relative to the flat cable.

26. The method of claim 23, further comprising:
applying the laser beam to the target portion of the coating at an end portion of the coating on only one planar side of the coating at a time
removing a target portion of the coating from the substrate with the defocused laser beam at an end portion of the coating of the flat cable on only one planar side of the coating of the flat cable at a time, without contemporaneously substantially removing coating from the end portion of the coating of the flat cable on the opposite planar side of the coating of the flat cable.

27. The method of claim 23, further comprising:
applying the laser beam to the target portion of the coating at an intermediate portion of the coating on only one planar side of the coating at a time; and
removing a target portion of the coating from the substrate with the defocused laser beam at an intermediate portion of the coating of the flat cable on only one planar side of the coating of the flat cable at a time, without contemporaneously substantially removing coating from the intermediate portion of the coating of the flat cable on the opposite planar side of the coating of the flat cable.
